(19) United States
(12) Patent Application Publication
(10) Pub. No.: US 2009/0277024 A1
(43) Pub. Date: Nov. 12, 2009

(54) DEVICE FOR SUPPLYING A SHAVING AID TO AN ELECTRIC SHAVER OR A COMPONENT OF AN ELECTRIC SHAVER

(75) Inventors: Anke Sinnema, Drachten (NL); Jasper Zuidervaart, Drachten (NL); Onno Hoitinga, Drachten (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/722,165

(22) PCT Filed: Dec. 15, 2005
(86) PCT No.: PCT/IB2005/054182

§ 371 Date: Jun. 19, 2007

(30) Foreign Application Priority Data
Dec. 20, 2004 (EP) 04106713.3

(51) Int. Cl. B26B 19/40; A45D 27/46

(52) U.S. Cl. 30/538; 132/292; 30/541

(57) ABSTRACT

A device (1) for supplying shaving aid (10) to cutting units (22) of an electric shaver (20) is designed as a stand-alone unit which is to be arranged separately from the shaver (20), and which is adapted to receiving the shaver (20). As a consequence of this design, this supplying device (1) may be designed such as to contain more shaving aid (10) than any supplying device that needs to be positioned inside the shaver (20), so that the need for a user to replenish the shaving aid (10) arises less frequently. The supplying device may further comprise means for performing at least one other function than supplying a shaving aid (10) to a shaver (20), for example a function of cleaning a shaving head (21) of the shaver (20) and/or a function of charging a battery of the shaver (20).

The present invention relates to a device for supplying a shaving aid to an electric shaver, and to a device for supplying a shaving aid to a component of an electric shaver. The invention further relates to a system comprising an electric shaver and a device for supplying a shaving aid to the shaver.

A supplying device for supplying a shaving aid to a rotatable cutter of an electric shaver is known from EP 0 858 384. The known supplying device is incorporated in the shaver, and comprises a holder filled with a shaving liquid, and a pump for pumping the fluid to an outlet opening arranged near the cutter of the shaver. The pump and the holder are detachably arranged with respect to each other, and both the pump and the holder are detachably arranged with respect to the shaver. In case the holder is empty, a user of the shaver needs to replace the empty holder by a full holder in order to obtain a renewed supply of the shaving liquid.

Another known device for supplying a shaving aid to a cutter of an electric shaver is disclosed by EP 1 353 982. This known supplying device comprises an assembly of an annular element that is adapted to be fitted narrowly around the cutter of the shaver and a central surface connected to the annular element, wherein a lubricant disc is provided on the central surface. When the lubricant disc is exhausted, a user of the shaver needs to remove the annular element from the cutter and place a new annular element, which is provided with a fresh lubricant disc, on the cutter.

A disadvantage of the supplying device known from EP 0 858 384 is that in case the holder is empty, the user needs to take quite extensive action in order to replace the empty holder by a full holder. In particular, the user needs to remove a wall portion from the shaver, to disconnect the empty holder from the wall portion, to attach a full holder to the wall portion, and to put the wall portion in place again. Likewise, in the case of the supplying device known from EP 1 353 982, in case the lubricant disc is exhausted, the user needs to remove the lubricant disc and to replace it by a fresh one. Moreover, in both cases, replacement of the holder and the lubricant disc, respectively, needs to take place quite often when the shaver is used on a day-to-day basis. This disadvantage is related to the fact that the sizes of the holder and the lubricant disc, respectively, are limited. Even in case of the holder, it is necessary that its size is not larger than a certain maximum, as it is incorporated in the shaver, which is a hand-held appliance, and is therefore not allowed to get too heavy or too voluminous.

The present invention provides an alternative for the known devices for supplying a shaving aid to a cutter of an electric shaver, in the form of a device for supplying a shaving aid to an electric shaver which is designed as a stand-alone unit which is to be arranged separately from the shaver.

The supplying device according to the present invention has many advantages. Some of these advantages will now be mentioned and elucidated.

In the first place, due to the fact that the supplying device according to the present invention is designed as a stand-alone unit, which is to be arranged separately from the shaver, the device is capable of containing a significantly larger quantity of the shaving aid than the known devices. Therefore, the shaving aid runs out less frequently, and actions aimed at replenishing the shaving aid need to be performed less frequently as well.

In the second place, the supplying device according to the present invention may easily be combined with another device, for example a device for cleaning a shaving head of the shaver, or a device for charging the shaver. In case the device according to the present invention is combined with a device for cleaning a shaving head of the shaver, it is possible to supply a mixture of a cleaning fluid and a “dry” shaving aid such as talcum powder to the shaving head, and to let the cleaning fluid evaporate, after which a layer of shaving aid is obtained on the shaving head.

Preferably, the supplying device according to the present invention comprises a holder for receiving and holding the shaver, so that it is not necessary for a user of the supplying device to put the shaver to a position for properly receiving the shaving aid and hold the shaver at that position. The holder may be movably arranged in order to be capable of moving the shaver to and from a position for receiving the shaving aid.

Various ways of applying the shaving aid exist. For example, the supplying unit according to the present invention may be adapted to allowing for direct contact between the shaver and a quantity of shaving aid. The supplying unit may be equipped with applying means for applying the shaving aid to the shaver, wherein the applying means may be movably arranged, for example between a first position for receiving the shaving unit from a container and a second position for contacting the shaver. According to another feasible possibility, the supplying unit may be equipped with spraying means for spraying the shaving aid.

In a preferred embodiment, the supplying device according to the present invention comprises means for removing contamination such as residue or debris from the shaver. An area of the shaver where the shaving aid is to be applied may be contaminated, for example by residue of shaving aid. When the supplying device comprises means for removing contamination, it is achieved that the shaving aid is supplied to a clean area. Naturally, the means for removing contamination are applied before the process of supplying shaving aid is performed.

The supplying device may be suitable for receiving and holding an electric shaver and supplying shaving aid to a specified area of the shaver, but that does not alter the fact that the supplying device may as well be suitable for supplying shaving aid to a component of an electric shaver. For example, a shaving head of the shaver may be removably arranged, so that a user is enabled to remove the shaving head from the shaver, to place the shaving head in the supplying device, to take the shaving head out of the supplying device after the process of supplying shaving aid has been performed, and to put the shaving head in place in the shaver again. It is also possible that the shaver comprises a removably arranged cartridge for containing shaving aid, which may be refilled by means of the supplying device.

The present invention also relates to a device for receiving and treating an electric shaver, comprising cleaning means for cleaning a functional unit of the shaver; and shaving aid supplying means for supplying a shaving aid to the shaver. In such a device, the supplying device according to the invention is combined with a device for cleaning a functional unit of the shaver. Such a combination is very advantageous, as both functions of cleaning the functional unit of the shaver and supplying a shaving aid to the shaver may be performed on the shaver when it is in held in one and the same holder. In this way, a situation in which two separate devices need to be applied is avoided.

Usually, a functional unit of an electric shaver is a portion of the shaver where cutting means are arranged. Furthermore, in many practical embodiments of electric shavers, the functional unit comprises a so-called hair chamber for receiving cut-off hairs. Normally, a cleaning process is specifically aimed at cleaning the hair chamber.

Within the scope of the present invention, the way in which a cleaning process is performed by the cleaning means of a combined device may be chosen freely. In a practical embodiment, the cleaning means are adapted to establishing contact between the functional unit of the shaver and a cleaning fluid. In such an embodiment, the functional unit of the shaver is cleaned under the influence of a flow of the cleaning fluid, wherein the flow may for example be generated by an activation of movably arranged cutting means of the shaver.

In a preferred embodiment, the combined device comprises a single container for containing a mixture of a cleaning fluid and a shaving aid. When the mixture is supplied to the shaver, the process of cleaning the functional unit of the shaver and the process of applying a layer of shaving aid to this functional unit, in particular the cutting means, take place more or less simultaneously. At the end of the combined cleaning and supplying process, the cleaning fluid is removed by rinsing and evaporation, while the shaving aid stays behind. Within the scope of the present invention, it is also possible that the combined device comprises separate containers for containing the cleaning fluid and the shaving aid, and that the combined device is adapted to performing the process of cleaning the functional unit of the shaver and the process of applying a layer of shaving aid to this functional unit in that order.

Advantageously, the combined device also comprises charging means for charging a battery of the shaver. Furthermore, the combined device may comprise means for removing contamination from the shaver.

The combined device may be suitable for receiving and holding an electric shaver, cleaning a shaving unit of the shaver and supplying shaving aid to a specified area of the shaver, but that does not alter the fact that the combined device may as well be suitable for treating only a component of an electric shaver. Therefore, the present invention also relates to a device for receiving and treating a component of an electric shaver, comprising cleaning means for cleaning the shaver component; and shaving aid supplying means for supplying a shaving aid to the shaver component. The above-mentioned possibilities regarding a combined device for treating a shaver apply in a similar manner also to the combined device for treating a shaver component, with the exception of the possibility of the combined device further comprising charging means in case the shaver component does not comprise the battery of the shaver.

The present invention further relates to a device for receiving and treating an electric shaver, comprising charging means for charging a battery of the shaver; and shaving aid supplying means for supplying a shaving aid to the shaver.

The present invention also relates to a system comprising an electric shaver and a device for supplying a shaving aid to the shaver.

The present invention will now be explained in greater detail with reference to the Figures, in which similar parts are indicated by the same reference signs, and in which:

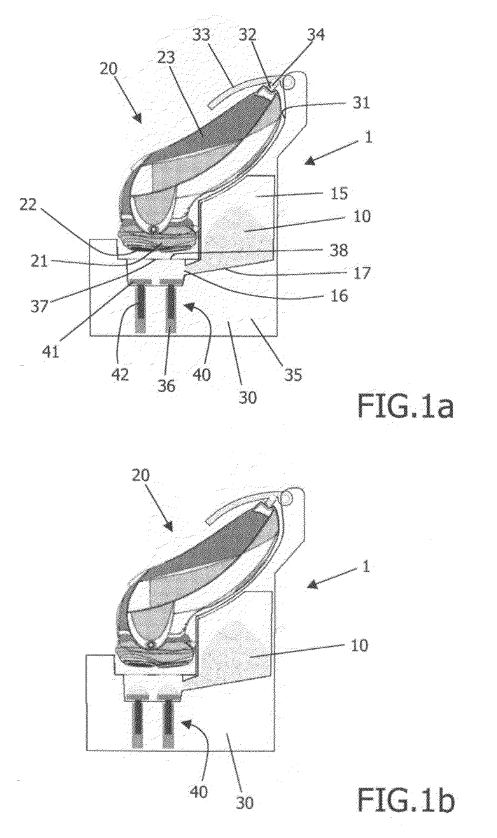

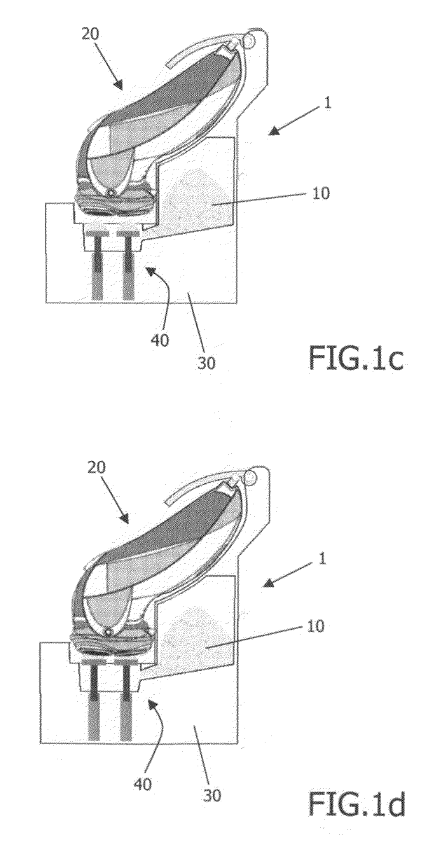

FIGS. 1a-1d diagrammatically show a side view of a first embodiment of a device for supplying a shaving aid to a shaving head of an electric shaver, in four subsequent conditions, and a shaver positioned in the device;

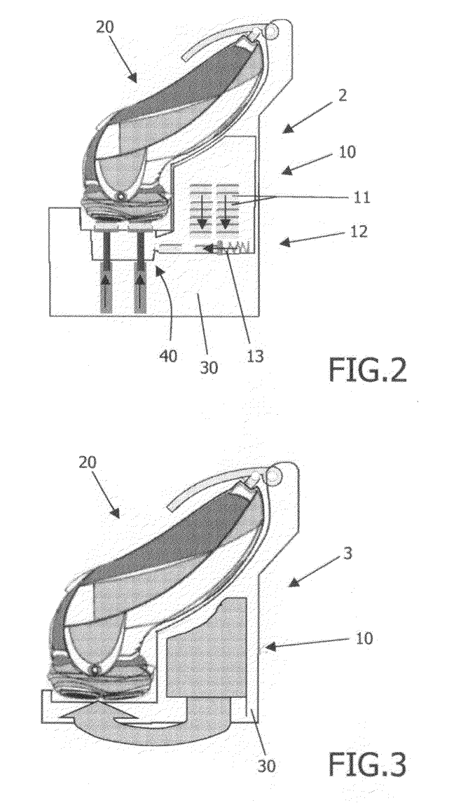

FIG. 2 diagrammatically shows a side view of a second embodiment of a device for supplying a shaving aid to a shaving head of an electric shaver, and a shaver positioned in the device;

FIG. 3 diagrammatically shows a side view of a third embodiment of a device for supplying a shaving aid to a shaving head of an electric shaver, and a shaver positioned in the device;

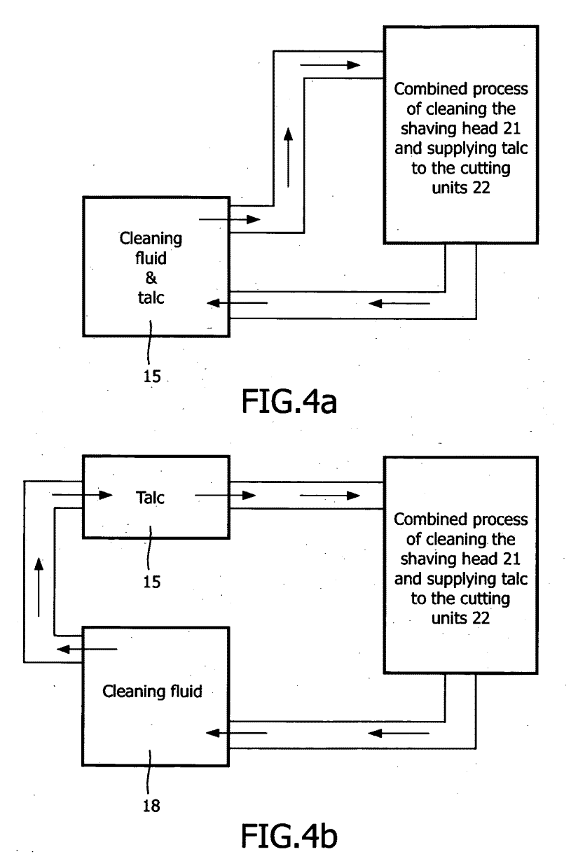

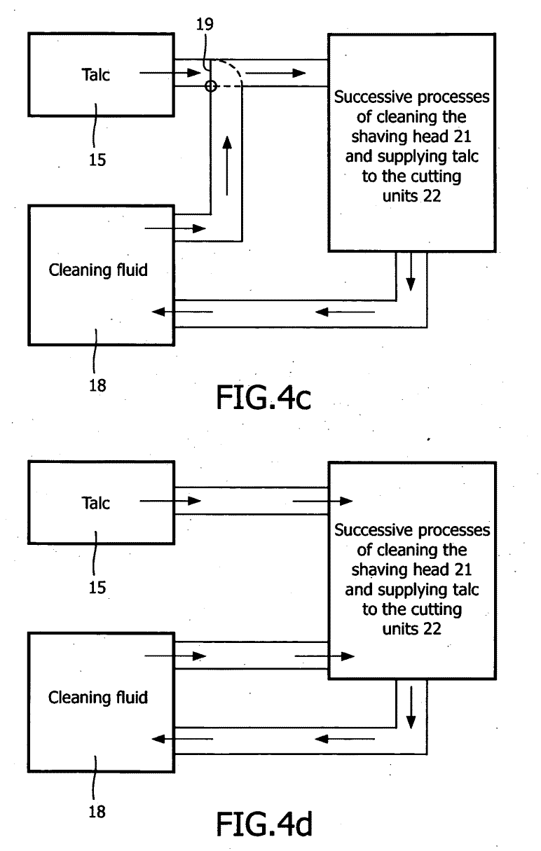

FIGS. 4a-4d illustrate four different possibilities for integrating a supply of a dry shaving aid and a supply of cleaning fluid in a single device for treating an electric shaver;

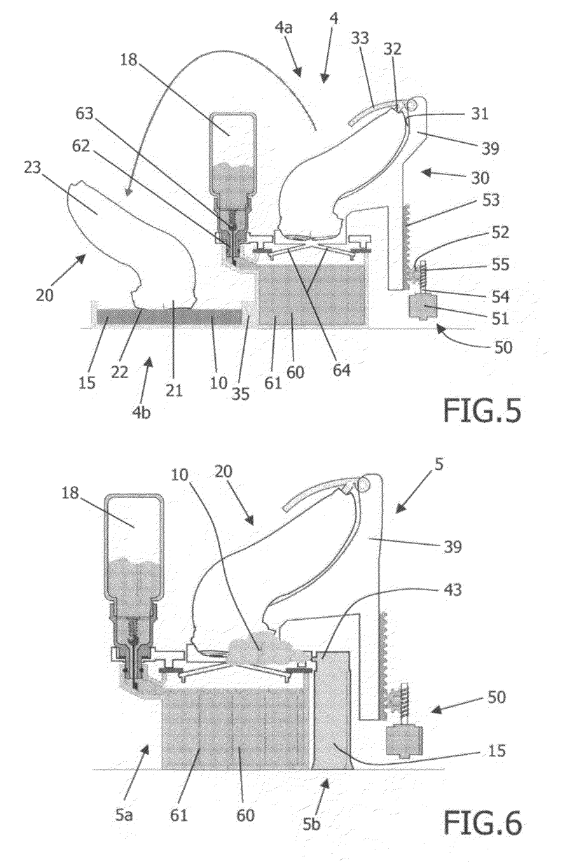

FIG. 5 diagrammatically shows a side view of a first embodiment of a device for cleaning a shaving head of an electric shaver and for supplying a shaving aid to the shaving head, and a shaver positioned in the device, in two possible positions;

FIG. 6 diagrammatically shows a side view of a second embodiment of a device for cleaning a shaving head of an electric shaver and for supplying a shaving aid to the shaving head, and a shaver positioned in the device;

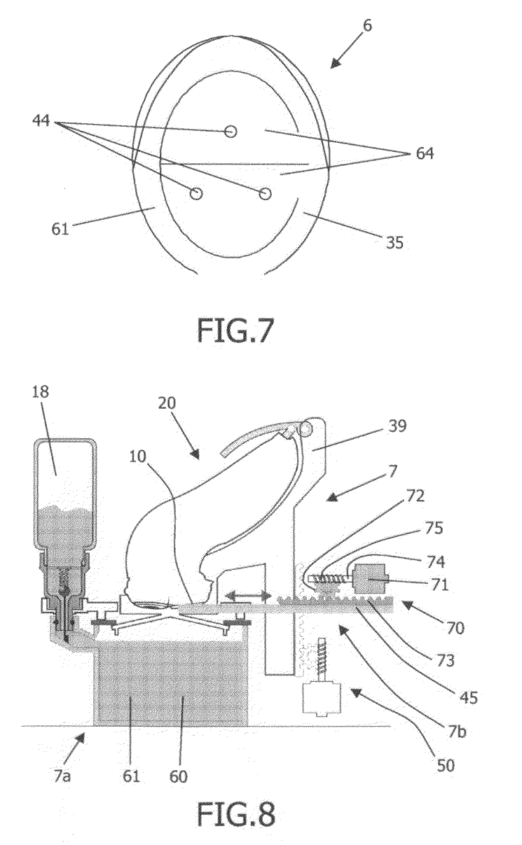

FIG. 7 diagrammatically shows a top view of a portion of a third embodiment of a device for cleaning a shaving head of an electric shaver and for supplying a shaving aid to the shaving head; and

FIG. 8 diagrammatically shows a side view of a fourth embodiment of a device for cleaning a shaving head of an electric shaver and for supplying a shaving aid to the shaving head, and a shaver positioned in the device.

FIGS. 1a-1d show a first device 1 for supplying a shaving aid 10 to a shaving head 21 of an electric shaver 20, and a shaver 20 positioned in the first supplying device 1.

The electric shaver 20 is known per se, and comprises a shaving head 21 on which a number of cutting units 22 for actually cutting off hairs of a user are mounted. During operation of the shaver 20, the cutting units 22 are driven by an electrical driving unit (not shown) of the shaver, wherein electric power is supplied by a rechargeable battery (not shown as well). When a user moves the shaving head 21 with the cutting units 22 with respect to his skin, hairs extending from the skin are cut off by the cutting units 22. For further details of the cutting units 22 and the operation thereof, reference is made to EP 0 719 203.

Besides the shaving head 21, the electric shaver 20 comprises a grip portion 23, which has many functions, among which enabling the user to firmly hold the shaver 20, and accommodating the battery and the electrical driving unit.

The first supplying device 1 comprises a housing 30, which is adapted to supporting the shaver 20. For this purpose, the housing 30 comprises a supporting surface 31, which is shaped in such a way that it is capable of contacting a substantial portion of the grip portion 23 of the shaver 20. For the purpose of securing a shaver 20 which is positioned in the housing 30, the first supplying device 1 comprises a connecting member 32, which is operable by the user to be put in a condition of engaging an end part of the grip portion 23 of the shaver 20. In the shown example, the connecting member 32 is operable by means of a lever 33, wherein a first position or closed position of the lever 33 corresponds to a condition of the connecting member 32 in which the connecting member 32 engages the end part of the grip portion 23 of the shaver 20, and wherein a second position or opened position of the lever 33 corresponds to a condition of the connecting member 32 in which the connecting member 32 is not capable of engaging the end part of the grip portion 23 of the shaver 20. Thus, when the shaver 20 is positioned in the housing 30 of the first supplying device 1, the shaver 20 is secured by moving the lever 33 from the opened position to the closed position. Subsequently, the shaver 20 is released by moving the lever 33 from the closed position to the opened position.

Advantageously, the connecting member 32 comprises an electrical contact member 34 for electrically contacting an electrical contact member (not shown) of the shaver 20 when the shaver 20 is positioned in the housing 30 and the lever 33 is in the closed position. The electrical contact between the respective contact members may be used to charge the battery of the shaver 20.

Inside the housing 30, a container 15 for containing the shaving aid 10 is arranged. The shaving aid 10 may be in the form of a powder or a paste, for example.

For the purpose of supplying the shaving aid 10 to the cutting units 22, the first supplying device 1 comprises a number of applicator units 40, which are movably arranged in a substantially vertical direction. A configuration of the applicator units 40 corresponds to a configuration of the cutting units 22 on the shaving head 21 of the shaver 20. The applicator units 40 are arranged in a base part 35 of the housing 30, so that the shaving head 21 of the shaver 20 is above the applicator units 40 when the shaver 20 is positioned in the first supplying device 1. In the shown example, the applicator units 40 comprise a disc-shaped upper part 41 which is supported by a cylindrical shaft 42. The cylindrical shaft 42 extends in a guiding passage 36 in the base part 35 of the housing 30.

The container 15 for containing the shaving aid 10 has an opening 16, at a side where the applicator units 40 are arranged. Any suitable means may be provided for blocking the opening 16 when the shaving aid 10 needs to remain inside the container 15 and for unblocking the opening 16 when the shaving aid 10 needs to be supplied to the upper parts 41 of the applicator units 40. Furthermore, any suitable means may be provided for ensuring that the shaving aid 10 flows from the container 15 to the upper parts 41 of the applicator units 40 when the opening 16 of the container 15 is unblocked. In FIGS. 1a-1d, it is shown that a bottom 17 of the container is sloping in a direction towards the opening 16. Thus, under the influence of gravity, it is ensured that a flow of the shaving aid 10 inside the container 15 towards the opening 16 is obtained.

When the shaver 20 is positioned in the first supplying device 1, the shaving head 21 of the shaver 20 is positioned right above a cover 37 covering an area where the applicator units 40 are arranged and where the opening 16 of the container 15 is. The cover 37 is provided with holes 38. Dimensions of the holes 38 are adapted to dimensions of the upper parts 41 of the applicator units 40 in such a way that the holes 38 are capable of letting through these upper parts 41.

In FIGS. 1a-1d, four steps in a process of supplying shaving aid 10 to the cutting units 22 of the shaver 20 are illustrated.

In FIG. 1a, a starting condition of the first supplying device 1 is shown. In the starting condition, the opening 16 of the container 15 is blocked, and the upper parts 41 of the applicator units 40 are positioned at a level right below the opening 16.

Starting from the starting condition, when the opening 16 of the container 15 is unblocked, a flow of shaving aid 10 towards the upper parts 41 of the applicator units 40 is obtained. As soon as a pre-determined amount of shaving aid 10 is supplied to the applicator units 40, the opening 16 is blocked again. The obtained condition of the first supplying device 1, in which shaving aid 10 is present on the upper parts 41 of the applicator units 40, and in which the opening 16 of the container 15 is blocked again, is shown in FIG. 1b.

In order to apply the shaving aid 10 to the cutting units 22 of the shaver 20, the applicator units 40 are moved towards the cutting units 22. In the process, the shafts 42 of the applicator units 40 slide in the guiding passages 36 in the base part 35 of the housing 30. Any suitable means may be provided for bringing about the movement of the applicator units 40. A position of the applicator units 40, in which the upper parts 41 have moved from a level below the opening 16 of the container 15 to a higher level, is shown in FIG. 1c.

The applicator units 40 are moved further with respect to the base part 35 of the housing 30, until the upper parts 41 pass the cover 37 and the shaving aid 10 on the upper parts 41 reaches the cutting units 22 of the shaver 20. At that moment, the process of supplying shaving aid 10 to the cutting units 22 is completed. The first supplying device 1 may comprise pressing means for bringing pressure to bear on the applicator units 40, in order to achieve that the shaving aid 10 is pressed on the cutting units 22.

After the shaving aid 10 has been transferred from the upper parts 41 of the applicator units 40 to the cutting units 22 of the shaver 20, the applicator units 40 are retracted, and the first supplying device 1 is put in the starting condition again. At that time, the shaver 20 is ready to be taken out of the first supplying device 1 and to be used in a shaving action.

By using the first supplying device 1, it is very easy for the user to supply the shaving aid 10 to the cutting units 22 of the shaver 20. All that the user needs to do, is to position the shaver 20 in the first supplying device 1, put the lever 33 to the closed position, and start a process in which shaving aid 10 is applied to the upper parts 41 of the applicator units 40, and in which the applicator units 40 are moved towards the shaving head 21 of the shaver 20. The first supplying device 1 may be adapted to starting the process of supplying shaving aid 10 to the cutting units 22 of the shaver 20 automatically when the shaver 20 is positioned in the device 1 and the lever 33 is put from the opened position to the closed position. It is also possible that the process of supplying shaving aid 10 to the cutting units 22 of the shaver 20 needs to be started by the user, wherein the first supplying device 1 is provided with a button or the like for receiving input from the user.

It is not necessary that the first supplying device 1 comprises a supporting surface 31 for supporting a substantial portion of the grip portion 23 of the shaver 20 and a connecting member 32 for locking the shaver 20 in the device 1. When a device 1 not being adapted to supporting and holding the shaver 20 is applied, the user himself presses the shaver 20 against the upper parts 41 of the applicator units 40 when the device 1 is in a condition in which the upper parts are extending through the holes 38 in the cover 37.

The cover 37 is not an essential component of the first supplying device 1, but it is preferred to have this cover 37, as it contributes to a clean design of the device 1.

FIG. 2 shows a second device 2 for supplying a shaving aid 10 to the shaving head 21 of an electric shaver 20, and a shaver 20 positioned in the second supplying device 2.

The second supplying device 2 resembles the first supplying device 1 to a large extent. A difference between these two devices 1, 2 is related to the form of the applied shaving aid 10 and the way in which the shaving aid 10 is supplied to the upper parts 41 of the applicator units 40.

In the second supplying device 2, the shaving aid 10 is provided in the form of discrete blocks 11. For example, the blocks 11 may comprise adhesive tablets of shaving aid 10, or click-on components in which a tablet of shaving aid 10 is integrated. Preferably, the blocks 11 are stored inside the container 15 in stacks, in a magazine-like fashion, wherein pushing means 12 are provided for pushing blocks 11 at an under side of the stacks out of the container 15 to the upper parts 41 of the applicator units 40, through the opening 16. The pushing means 12 may comprise any suitable means, and may for example be provided with a spring 13. In FIG. 2, a direction in which the blocks 11 move is indicated by means of arrows.

FIG. 3 shows a third device 3 for supplying a shaving aid 10 to the shaving head 21 of an electric shaver 20, and a shaver 20 positioned in the third supplying device 3.

Like the first supplying device 1 and the second supplying device 2, the third supplying device 3 comprises a housing 30 having a supporting surface 31 for contacting a substantial portion of the grip portion 23 of the shaver 20, a connecting member 32 for engaging an end part of the grip portion 23 of the shaver 20, and a container 15 for containing shaving aid 10.

The third supplying device 3 is adapted to supplying a fluid to the cutting units 22 of the shaver 20, comprising suitable means such as sprayers which may be pressurized to spray the fluid. In FIG. 3, the supply of the fluid from the container 15 to the shaving head 21 of the shaver 20 is diagrammatically depicted by means of an arrow. A practical embodiment of the means for supplying the fluid to the cutting units 22 of the shaver 20 is not shown.

The third supplying device 3 is suitable for supplying a fluid like a shaving aid in a liquid form or a mixture of a fluid and particles of a solid shaving aid to the cutting units 22 of the shaver 20. In case a fluid containing particles of a solid shaving aid is supplied to the cutting units 22, the shaver 20 is ready to be used as soon as the fluid has evaporated and a layer of the shaving aid remains on the cutting units 22.

In the third supplying device 3, a fluid is supplied to the cutting units 22 of the shaver 20 for the purpose of providing the cutting units 22 with a layer of shaving aid. Within the scope of the present invention, it is possible mat the fluid is a cleaning fluid for cleaning the shaving head 21 of the shaver 20, in particular a hair chamber (not shown) arranged in the shaving head 21 for receiving cut-off hairs, and that the process of supplying shaving aid to the cutting units 22 is combined with a process of cleaning the shaving head 21. In this respect, it is noted that devices for spraying a cleaning fluid on the shaving head 21 are known, for example from U.S. Pat. No. 5,711,328.

Various ways of combining a supply of a cleaning fluid and talc as a shaving agent are illustrated by FIGS. 4a-4d. In these Figures, paths followed by the cleaning fluid and the talc are diagrammatically indicated by means of arrows.

According to a first possibility as illustrated by FIG. 4a, a device for cleaning the shaving head 21 of a shaver 20 and supplying talc to the cutting units 22 of the shaver 20 comprises a single container 15, in which a mixture of cleaning fluid and talc is stored. By supplying this mixture to the shaver 20, the shaver 20 is cleaned and, at the same time, provided with talc. The shaver 20 is ready for use when the cleaning fluid has rinsed away. Preferably, the cleaning fluid is fed back to the container 15, so that the cleaning fluid may be used for following cleaning processes.

According to a second possibility as illustrated by FIG. 4b, a device for cleaning the shaving head 21 of a shaver 20 and supplying talc to the cutting units 22 of the shaver 20 comprises two separate containers, wherein one container 15 serves for storing the talc, and wherein another container 18 serves for storing the cleaning fluid. When the combined process of cleaning the shaving head 21 of a shaver 20 and supplying talc to the cutting units 22 of the shaver 20 is started, the cleaning fluid is conducted through an amount of talc, so that the talc is carried along with the cleaning fluid to the shaver 20. By supplying both the cleaning fluid and the talc to the shaver 20, the shaver 20 is cleaned and, at the same time, provided with talc. The shaver 20 is ready for use when the cleaning fluid has rinsed away. Preferably, the cleaning fluid is fed back to the container 18, so that the cleaning fluid may be used for following cleaning processes.

According to a third possibility as illustrated by FIG. 4c, a device for cleaning the shaving head 21 of a shaver 20 and supplying talc to the cutting units 22 of the shaver 20 comprises two separate containers, wherein one container 15 serves for storing the talc, and wherein another container 18 serves for storing the cleaning fluid. Furthermore, the device comprises a valve 19 or similar means for allowing either a flow of cleaning fluid or a flow of talc to the shaver 20. In this way, it is possible to first subject the shaver 20 to a cleaning process, and supply the talc to the shaver 20 right after the cleaning process has taken place. Preferably, at the end of the cleaning process, the cleaning fluid is fed back to the container 18, so that the cleaning fluid may be used for following cleaning processes.

According to a fourth possibility as illustrated by FIG. 4d, a device for cleaning the shaving head 21 of a shaver 20 and supplying talc to the cutting units 22 of the shaver 20 comprises two separate containers, wherein one container 15 serves for storing the talc, and wherein another container 18 serves for storing the cleaning fluid. The device is adapted to realizing separate supplies of cleaning fluid and talc to the shaver 20. Therefore, the processes of cleaning the shaving head 21 of the shaver 20 and supplying talc to the cutting units 22 of the shaver 20 may be performed simultaneously, but these processes may also be performed successively, wherein the latter possibility is preferred. It is also preferred that, at the end of the cleaning process, the cleaning fluid is fed back to the container 18, so that the cleaning fluid may be used for following cleaning processes.

In FIG. 5, a first embodiment of a device for cleaning a shaving head 21 of an electric shaver 20 and for supplying a shaving aid 10 to the cutting units 22 of the shaver 20 is shown, and indicated by reference numeral 4. In the following, for sake of simplicity, a device for cleaning a shaving head 21 of an electric shaver 20 and for supplying a shaving aid 10 to the cutting units 22 of the shaver 20 will be referred to as combined device. Furthermore, in FIG. 5, two possible positions of the shaver 20 in the first combined device 4 are shown.

One portion 4a of the first combined device 4 is adapted to cleaning the shaving head 21 of the shaver 20, and will hereinafter be referred to as cleaning unit 4a, whereas another unit 4b of the first combined device 4 is adapted to supplying the shaving aid 10 to the cutting units 22 of the shaver 20, and will hereinafter be referred to as supplying unit 4b.

In the first combined device 4, the cleaning unit 4a and the supplying unit 4b are connected to each other. The supplying unit 4b comprises an open container 15 for containing the shaving aid 10. For the purpose of applying the shaving aid 10 to the cutting units 22 of the shaver 20, a user needs to press the shaving head 21 of the shaver 20 on the shaving aid 10 that is present in the container 15. Preferably, the user performs this action after the shaving head 21 has been cleaned by means of the cleaning unit 4a of the first combined device 4. The way in which the cleaning unit 4a is designed and applied will now be explained.

Like the supplying devices 1, 2, 3 as shown in FIGS. 1a-1d, 2 and 3, the cleaning unit 4a of the first combined device 4 comprises a housing 30 having a supporting surface 31 for contacting a substantial portion of the grip portion 23 of the shaver 20, a connecting member 32 for engaging an end part of the grip portion 23 of the shaver 20, and a lever 33 for operating the connecting member 32. An upper part 39 of the housing 30, which is adapted to supporting and holding the shaver 30, is movably arranged in a substantially vertical direction. For the purpose of displacing the upper part 39 of the housing 30, any suitable displacing means 50 may be applied. As an example, in FIG. 5, one possible embodiment of the displacing means 50 is shown. The displacing means 50 comprise an electrical motor 51, a transmission gear 52, and a gear rack 53 arranged on the upper part 39 of the housing 30. An output shaft 54 of the electrical motor 51 is provided with a relief 55 that is fit for engaging the transmission gear 52. When the output shaft 54 is rotated, cooperation between the relief 55 on the output shaft 54 and the transmission gear 52 causes the transmission gear 52 to rotate. Besides the relief 55 on the output shaft 54 of the electrical motor 51, the transmission gear 52 engages the gear rack 53 arranged on the upper part 39 of the housing 30. As a result of this arrangement, a rotation of the transmission gear 52 causes a displacement of the upper part 39 of the housing 30.

In a base part 35 of the housing 30, a basin 61 for containing the cleaning fluid 60 is arranged. The first combined device 4 further comprises a container 18 for containing cleaning fluid 60, which is suitable for supplying cleaning fluid 60 to the basin 61, which is arranged at a level above the basin 61. A passage 62 between the container 18 and the basin 61 is closable by means of a valve ball 63.

An open top side of the basin 61 is closable by means of two plate-shaped pivotable closing members 64. The closing members 64 are normally in a closed position, in which the closing members 64 close off the basin 61, in order to limit evaporation of the cleaning fluid 60. For the purpose of normally keeping the closing members 64 in the closed position, but also allowing for an opened position of the closing members 64, suitable means such as springs (not shown) are provided.

When a shaver 20 is positioned in the upper part 39 of the housing 30 of the cleaning unit 4a of the first combined device 4, and the cleaning unit 4a is activated, the displacement means 50 are operated such as to lower the upper part 39 of the housing 30, starting from a pre-determined upper position of the upper part 39 of the housing 30. In the process, a portion of the upper part 39 of the housing 30 surrounding the shaving head 21 of the shaver 20 pushes against the closing members 64, thereby putting the closing members 64 from the closed position to an opened position. When the shaving head 21 is immersed in the cleaning fluid 60 that is present in the basin 61, and the upper part 39 of the housing 30 has reached a pre-determined lower position, the displacement of the upper part 39 of the housing 30 is stopped.

The cleaning process involves an activation of the shaver 20, wherein the cutting units 22 are rotated. For the purpose of controlling the displacement of the upper part 39 of the housing 30 and the operation of the shaver 20, the first combined device 4 comprises a control unit (not shown). Due to the rotational motion of the cutting units 22, an effective cleaning process of the cutting units 22 is obtained.

The cleaning process is finished by shutting off the shaver 20 and activating the displacement means 50 to raise the upper part 39 of the housing 30 to the upper position. In the process, the closing members 64 move back to the closed position. After the cleaning fluid that remains behind in the shaving head 21 has evaporated, the shaver 20 is ready to be taken out off the upper part 39 of the housing and to be used in a shaving action. In case a user of the shaver 20 wants to apply shaving aid 10, he presses the shaving head 21 of the shaver 20 on the shaving aid 10 present in the container 15 of the supplying unit 4b of the first combined device 4. In FIG. 5, the movement of the shaver 20 from the cleaning unit 4a of the first combined device 4 to the supplying unit 4b of the first combined device 4 is diagrammatically indicated by means of a curved arrow.

Within the scope of the present invention, the design of the cleaning unit 4a of the first combined device 4 may deviate from the design as described with reference to FIG. 5. A particular feature of the first combined device 4 is that this device 4 comprises a supplying unit 4b having an open container 15 for containing the shaving aid 10.

When a user applies the first combined device 4 as shown in FIG. 5, he needs to move the shaver 20 to the supplying unit 4b of the device 4 and press the shaving head 21 of the shaver 20 on the shaving aid 10 present in the container 15 of the supplying unit 4b, in order to supply shaving aid 10 to the shaver 20. Within the scope of the present invention, alternative combined devices are possible, which are adapted to performing the function of supplying shaving aid 10 to the shaver 20 in a manner that is more convenient to the user. In FIGS. 6-8, three such alternative combined devices are shown.

In FIG. 6, a second combined device 5 having a cleaning unit 5a and a supplying unit 5b is shown. The cleaning unit 5a of the second combined device 5 corresponds to the cleaning unit 4a of the first combined device 4. The supplying unit 5b comprises a container 15 for containing the shaving aid 10 and a sprayer 43 positioned on top of the container 15 for spraying the shaving aid 10 on the shaving head 21 of a shaver 20. The sprayer 43 is arranged at a level corresponding to a level where the shaving head 21 of the shaver 20 is when the upper part 39 of the housing 30 is in the upper position. In FIG. 6, a cloud of sprayed shaving aid 10 is diagrammatically depicted.

The sprayer 43 may be controlled by a user of the second combined device 5, and may for example be provided with a button, wherein the sprayer 43 is operated to release a cloud of shaving aid 10 when the user depresses the button. According to another option, the sprayer 43 is controlled by a control unit of the second combined device 5, which is also used for controlling the cleaning process. Preferably, in such case, the control unit is programmed such as to activate the sprayer 43 after the cleaning process has taken place.

FIG. 7 shows a top view of a base part 35 of a housing 30 of a third combined device 6. This base part 35 comprises a basin 61 for containing cleaning fluid and closing members 64 for closing off the basin 61. At a position right above the closing members 64 in a closed position, nozzles 44 for spraying shaving aid 10 on the cutting units 22 of a shaver 20 are arranged. A configuration of these nozzles 44 is adapted to a configuration of the cutting units 22 on the shaving head 21 of the shaver 20, so that each nozzle 44 is capable of directly spraying the shaving aid 10 on an associated cutting unit 22. The third combined device 6 comprises a supply of shaving aid 10 (not shown), for example a sprayer 43 as shown in respect of the second combined device 5, wherein the nozzles 44 are connected to this supply.

In FIG. 8, a fourth combined device 7 having a cleaning unit 7a and a supplying unit 7b is shown. The cleaning unit 7a of the fourth combined device 7 corresponds to the cleaning unit 4a of the first combined device 4. The supplying unit 7b comprises an applicator slide 45 that is movable in a substantially horizontal direction, and that is arranged at a level right above a level of the closing members 64 for closing off the basin 61 containing the cleaning fluid. In FIG. 8, the fact that the applicator slide 45 is movable in a substantially horizontal direction is diagrammatically indicated by means of a double-headed arrow.

For the purpose of displacing the applicator slide 45, displacement means 70 are provided. In the shown example, the displacement means 70 for displacing the applicator slide 45 comprise the same components as the displacement means 50 for displacing the upper part 39 of the housing 30, and functions in the same manner. Hence, the displacement means 70 for displacing the applicator slide 45 comprise an electrical motor 71, a transmission gear 72, and a gear rack 73 arranged on the applicator slide 45. An output shaft 74 of the electrical motor 71 is provided with a relief 75 that is fit for engaging the transmission gear 72.

Preferably, the supplying unit 7b is operated after the shaving head 21 of a shaver 20 has been subjected to a cleaning process. After this process has taken place, the upper part 39 of the housing 30 is put to the upper position, wherein it is possible to move a portion of the applicator slide 45 carrying an amount of shaving aid 10 between the shaving head 21 of the shaver 20 and the closing members 64. Subsequently, the displacement means 50 for displacing the upper part 39 of the housing 30 are operated to lower the upper part 39 of the housing 30 to a position where the shaving head 21 of the shaver 20 contacts the shaving aid 10 that is present on the applicator slide 45. As a result of this contact, the shaving aid 10 is applied to the cutting units 22 of the shaver 20. After the process of supplying shaving aid 10 has taken place, the displacement means 50 for displacing the upper part 39 of the housing 30 are operated to put the upper part 39 of the housing 30 to the upper position again, after which the displacement means 70 for displacing the applicator slide 45 are operated to retract the applicator slide 45, so that an area above the closing members 64 is free from obstructions again.

In a preferred embodiment, the applicator slide 45 is not only suitable to be used for the purpose of applying shaving aid 10 to a shaver 20, but also to be used for the purpose of closing off the basin 61 containing the cleaning fluid 60. In such an embodiment, the closing members 64 may be omitted.

A difference between the first combined device 4 and the other described combined devices 5-7 is that this device 4 does not comprise a holder or the like for holding the shaver 20 during a process in which the shaver 20 is supplied with shaving aid 10. The fact that it not necessary to carefully position the shaver 20 in the first combined device 4 for the purpose of supplying the shaver 20 with shaving aid 10 has the advantage that the use of this device 4 is relatively simple, and that the supplying process requires only little time, and can be performed at any desired moment, even in the course of a shaving action. Consequently, when the first combined device 4 is used, it is very well possible to add some extra shaving aid in the course of a shaving action, if so desired.

It is noted that the cleaning units of the shown combined devices 4-7 resemble to a large extent a number of cleaning devices as disclosed in European patent application 04103976.9 in the name of the present applicant. Within the scope of the present invention, it is possible that the cleaning units are designed as the disclosed cleaning devices.

It will be clear to a person skilled in the art that the scope of the present invention is not limited to the examples discussed in the foregoing, but that several amendments and modifications thereof are possible without deviating from the scope of the present invention as defined in the attached claims.

The electrical contact member 34 that has been described in relation to the first supplying device 1 may also be part of the other supplying devices 2, 3, and of the combined devices 4-7. In other words, in one device, the function of supplying shaving aid 10 to a shaver 20 may be combined with other functions, in particular the function of cleaning a shaving head 21 of the shaver 20 and the function of charging the battery of the shaver 20.

In the described examples, the shaving aid 10 is directly applied to a functional unit of the shaver 20. However, that does not alter the fact that the supplying devices 1-7 may also be applied for supplying shaving aid 10 to a container, a cavity or the like that is arranged in the shaver 20, for example at a location right beneath the cutting units 22, wherein the container, the cavity or the like is adapted to supplying the shaving aid to the cutting units 22. It is a practical possibility to use the hair chamber for the purpose of receiving the shaving aid.

The supplying units of the combined devices 4-7 are capable of functioning independently of the cleaning units. Therefore, these supplying units may also be performed as separate supplying devices, wherein components like the basin 61 and the container 18 are omitted. However, it is very advantageous to combine the functions of cleaning the shaving head 21 of a shaver 20 and supplying shaving aid 10 to the cutting units 22 of the shaver 20, as both functions may be performed on the shaver 20 when it is in held in one and the same holder. In such case, a user only needs to place the shaver 20 in the holder, and start the processes of cleaning the shaving head 21 and applying shaving aid 10 to the cutting units 22, which may be performed simultaneously, for example when a mixture of cleaning fluid 60 and shaving aid 10 is supplied, or successively.

The supplying device 1-7 according to the present invention may be used to supply any appropriate type of shaving aid 10. For example, the shaving aid 10 may comprise talc, but may also comprise other materials, such as boron nitride, small spheres of glass and/or plastics, of which a diameter is preferably smaller than 100 μm, starches, aluminium starch octenyl succinate, bismuth oxychloride, silicone powder, dimethicone vinyl, kaolin, mica powder, nylon powder, polyethylene, polymethyl methacrylate, polytetrafluoroethylene, zinc stearate, magnesium stearate, and tannine. The shaving aid 10 may also comprise lubrication lacquerings, or a mixture of materials, possibly comprising some materials having another function than enhancing a shaving performance, for example colorants. The shaving aid 10 may be applied in a liquid form and/or a solid form, in various ways, for example by spraying, gluing, or sticking. It is possible that aids such as carriers are used for applying the shaving aid 10.

The supplying device 1-7 according to the present invention may be used to supply shaving aid 10 to any type of shaver 20, for example a shaver 20 comprising a single elongated cutting unit. With respect to the first supplying device 1, it is noted that the number and the configuration of the applicator units 40 may be adapted to the number and the configuration of the cutting units of the shaver 20 that is to be supplied with the shaving aid. The same applies to the number and the configuration of the nozzles 44 of the third combined device 6.

Advantageously, the supplying device 1-7 according to the present invention comprises a control unit for controlling various aspects of the operation of the device 1-7. Hence, one or more sensors may be arranged for providing the control unit with information, for example a sensor for communicating to the control unit if a shaver 20 is present in the device 1-7. The shaver 20 may be equipped with a storing unit for storing information regarding the state of various components of the shaver 20. For example, when a process of supplying shaving aid 10 has been performed, the control unit of the supplying device 1-7 may communicate to the storing unit of the shaver 20 that the shaving aid 10 has been replenished, after which the storing unit may count the number of uses of the shaver 20 and communicate to the control unit that it is required to supply shaving aid 10 when the shaver 20 is placed in the supplying device 1-7 and the number of uses matches or exceeds a pre-determined number of uses.

In the foregoing, a device 1-7 for supplying shaving aid 10 to cutting units 22 of an electric shaver 20 has been described. The supplying device 1-7 is designed as a stand-alone unit which is to be arranged separately from the shaver 20, and which is adapted to receiving the shaver 20. As a consequence of this design, this supplying device 1-7 may be designed such as to contain more shaving aid 10 than any supplying device that needs to be positioned inside the shaver 20, so that the need for a user to replenish the shaving aid 10 arises less frequently. The supplying device 1-7 may further comprise means for performing at least one other function than supplying a shaving aid 10 to a shaver 20, for example a function of cleaning a shaving head 21 of the shaver 20 and/or a function of charging a battery of the shaver 20.

1. Device for supplying a shaving aid to an electric shaver, designed as a stand-alone unit which is to be arranged separately from the shaver.

2. Device according to claim 1, comprising a holder for receiving and holding the shaver.

3. Device according to claim 2, wherein the holder is movably arranged.

4. Supplying device according to claim 1, comprising applying means for applying a shaving aid to the shaver, allowing for direct contact between a functional unit of the shaver and the shaving aid.

5. Supplying device according to claim 4, wherein the applying means are movably arranged.

6. Supplying device according to claim 5, comprising pressing means for bringing pressure to bear on the applying means.

7. Supplying device according to claim 1, comprising spraying means for spraying a shaving aid.

8. Supplying device according to claim 1, comprising means for removing contamination such as residue, or debris from the shaver.

9. Device for supplying a shaving aid to a component of an electric shaver, designed as a stand-alone unit which is to be arranged separately from the shaver, and which is adapted to receiving and holding the shaver component.

10. Device for receiving and treating an electric shaver, comprising:
cleaning means for cleaning a functional unit of the shaver; and
shaving aid supplying means for supplying a shaving aid to the shaver.

11. Treatment device according to claim 10, wherein the cleaning means are adapted to establishing contact between the functional unit of the shaver and a cleaning fluid.

12. Treatment device according to claim 11, comprising a single container for containing a mixture of a cleaning fluid and a shaving aid.

13. Treatment device according to claim 11, comprising separate containers for containing a cleaning fluid and for containing a shaving aid.

14. Treatment device according to claim 10, further comprising charging means for charging a battery of the shaver.

15. Treatment device according to claim 10, further comprising means for removing contamination such as residue or debris from the shaver.

16. Device for receiving and treating a component of an electric shaver, comprising:
cleaning means for cleaning the shaver component; and
shaving aid supplying means for supplying a shaving aid to the shaver component.

17. Device for receiving and treating an electric shaver, comprising:
charging means for charging a battery of the shaver; and
shaving aid supplying means for supplying a shaving aid to the shaver.

18. System comprising an electric shaver and a device according to claim 17, arranged for cooperation with the shaver.
